(19) United States
(12) Patent Application Publication
(10) Pub. No.: US 2022/0413802 A1
(43) Pub. Date: Dec. 29, 2022

(54) COMPUTATION APPARATUS, METHOD AND PROGRAM FOR THE SAME

(71) Applicant: NIPPON TELEGRAPH AND TELEPHONE CORPORATION, Tokyo (JP)

(72) Inventors: Hiroki SUDO, Musashino-shi, Tokyo (JP); Dai IKARASHI, Musashino-shi, Tokyo (JP); Koki HAMADA, Musashino-shi, Tokyo (JP); Ryo KIKUCHI, Musashino-shi, Tokyo (JP); Atsunori ICHIKAWA, Musashino-shi, Tokyo (JP); Ibuki MISHINA, Musashino-shi, Tokyo (JP)

(73) Assignee: NIPPON TELEGRAPH AND TELEPHONE CORPORATION, Tokyo (JP)

(21) Appl. No.: 17/765,440

(22) PCT Filed: Oct. 7, 2019
(86) PCT No.: PCT/JP2019/039504

§ 371 Date: Mar. 31, 2022

(51) Int. Cl. G06F 7/535

(52) U.S. Cl. CPC G06F 7/535

(57) ABSTRACT

A computation apparatus, a method of the same, and a program which perform a secure computation using fixed-point arithmetic, and overflow is unlikely to occur and the occurrence of division by zero can be detected when an odds ratio is calculated. The computation apparatus includes an odds ratio computation unit for obtaining an odds ratio between a first group (a+b) and a second group (c+d) based on four plaintext values a, b, c, and d, by means of secure computation; a zero-division detection unit for determining, by means of secure computation, whether or not at least one of the plaintext values b and c is not zero, and detecting division by zero; and a selection unit for selecting the odds ratio if division by zero is not detected, by means of secure computation.

### TECHNICAL FIELD

The present invention relates to a computation apparatus for calculating an odds ratio by means of secure computation (hereinafter also referred to as “secure odds ratio computation”), a method of the same, and a program.

### BACKGROUND ART

The odds ratio is one of the frequently used statistics in medical statistics. The odds ratio can be calculated based on a 2×2 summary table. FIG. 1 shows an example of a 2×2 summary table in which n objects to be examined are classified by the presence or absence of base mutations and diseases, and the numbers of cases are counted up. The odds ratio o is defined by the following expression:

o=(a·d)/(b·c) (1)

Secure computation is one of the techniques for performing predetermined computation with input data encrypted. There are various encryption methods in secure computation, and an example is the method described in NPL 1. In the method in NPL 1, input data is subjected to encryption processing in which numerical values that express data are fragmented and distributed to three secure computation apparatuses. Each individual fragment is a seemingly random value, and the original value cannot be obtained unless the fragments are collected and restored. In the method in NPL 1, three secure computation apparatuses can perform addition, subtraction, multiplication, and logical operations with fixed-point numbers on the input data without restoring the input data by cooperating to perform computation. Division of fixed-point numbers can be realized using, for example, a method called secure batch mapping (see NPL 2).

In medical statistics, delicate data is dealt with and therefore security is very important. In previous studies on secure computation for medical statistics, a method of obtaining an odds ratio based on a weight learned by performing logistic regression analysis as in NPL 3 has been proposed.

### CITATION LIST

### Non Patent Literature

[NPL 1] Naoto Kiribuchi, Dai Ikarashi, Koki Hamada, Ryo Kikuchi, “MEVAL3: A Library for Programmable Secure Computation”, SCIS 2018, 2018.
[NPL 2] Koki Hamada, Dai Ikarashi, Koji Chida, “A Batch Mapping Algorithm for Secure Function Evaluation”, ISEC, 2012.
[NPL 3] Hiroaki Kikuchi, Hideki Hashimoto, Hideo Yasunaga, Kenji Shibuya, “Privacy-Preserving Propensity Score Matching for Evaluation of Outcomes Using the DPC Dataset”, Computer Security Symposium 2013 Proceedings, p. 110-117, 2013.

### SUMMARY OF THE INVENTION

### Technical Problem

However, a method for securely calculating the expression (1) has not been proposed. In a simple analysis without confounding factors, the computation of the expression (1) is sufficient, and thus the logistic regression calculation in NPL 3 is unnecessary in that case. That is to say, NPL 3 has a problem of performing logistic regression, which is very computationally expensive compared to arithmetic operations.

The present invention solves this problem by securely calculating the expression (1). Here, there are also two problems in the secure computation of the expression (1).

In the present invention, the secure computation of the expression (1) is performed using fixed-point arithmetic. The problem with computations using fixed-point numbers is that overflow tends to occur. To handle the case where the input value is large, it is necessary to devise computation to avoid overflow.

Next, division by zero may occur in a defining equation for the odds ratio, but the odds ratio cannot be defined if division by zero occurs. For this reason, the occurrence of division by zero needs be detected and distinguished from normal computation results. In the case of plain-text computations, it is easy to distinguish the normal computation results from invalid values, since errors can be checked by looking at intermediate results during the computation. However, if the secure computation of the expression (1) is performed as-is, the occurrence of division by zero cannot be detected and cannot be distinguished from the normal computation results.

An object of the present invention is to provide a computation apparatus, a method of the same, and a program with which secure computation is performed using fixed-point arithmetic, and overflow is unlikely to occur and the occurrence of division by zero can be detected when an odds ratio is calculated.

### Means for Solving the Problem

To solve the foregoing problems, according to an aspect of the present invention, a computation apparatus includes: an odds ratio computation unit for obtaining an odds ratio between a first group (a+b) and a second group (c+d) based on four plaintext values a, b, c, and d, by means of secure computation; a zero-division detection unit for determining, by means of secure computation, whether or not at least one of the plaintext values b and c is not zero, and detecting division by zero; and a selection unit for selecting the odds ratio if division by zero is not detected, by means of secure computation, wherein the odds ratio computation unit obtains ciphertexts [[o′₁]] and [[o′₂]] of results o′₁ and o′₂ of calculating a/b and d/c, respectively, by means of secure computation, and thereafter obtains a ciphertext [[o′]] of a result o′ of calculating o′₁×o′₂.

To solve the foregoing problem, according to another aspect of the present invention, a computation apparatus includes: a division unit for taking ciphertexts [[a]], [[b]], [[c]], and [[d]] of plaintext values a, b, c, and d as input, and obtaining ciphertexts [[o′₁]] and [[o′2]] of results o′₁ and o′₂ of calculating a/b and d/c, respectively, by [[o′₁]]←[[a]]/[[b]] and [[o′₂]]←[[d]]/[[c]], by means of secure computation; a multiplication unit for taking the ciphertexts [[o′i]] and [[o′2]] as input and obtaining a ciphertext [[o′]] of a result o′ of computation of plaintext values o′₁×o′₂ by [[o′]]77 [[o′₁]]×[[o′₂]], by means of secure computation; an equality judgment unit for taking the ciphertexts [[b]] and [[c]] as input and obtaining ciphertexts [[f₁]] and [[f₂]] of truth values f₁ and f₂ with predicates b=?0 and c=?0, respectively, by [[f₁]]←[[b]]=?[[0]] and [[f₂]]←[[c]]=?[[0]], by means of secure computation; a logical operation unit for taking the ciphertexts [[f₁]] and [[f₂]] as input and obtaining a ciphertext [[f]] of a result f of calculating f₁ Or f₂ by [[f]]←Or([[f₁]], [[f₂]]), by means of secure computation; and a selection unit for taking the ciphertexts [[f]] and [[o′]] as input and obtaining a ciphertext [[o]] of o that satisfies

$$o = \{ \begin{matrix}⊥ if f = 1 \\ {o}^{′} otherwise\end{matrix} \qquad [ Math . 1 ]$$

by [[o]]←If Else([[f]], [[⊥]], [[o′]]), by means of secure computation, wherein ⊥ indicates an invalid value.

### Effects of the Invention

The present invention has an effect that overflow is unlikely to occur and the occurrence of division by zero can be detected.

### BRIEF DESCRIPTION OF DRAWINGS

FIG. 1 is a diagram showing an example of a 2×2 summary table.

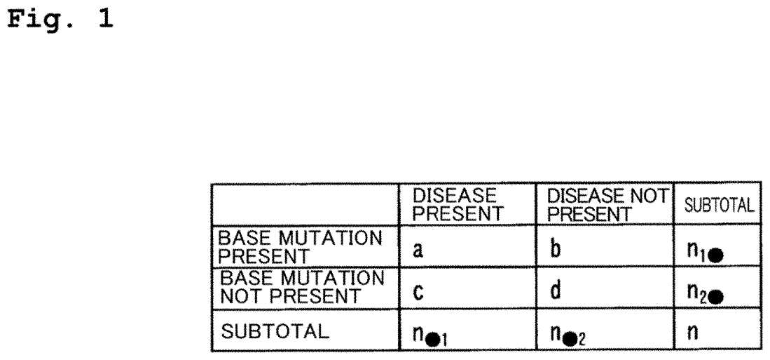

FIG. 2 is a functional block diagram of a computation apparatus according to a first embodiment.

FIG. 3 is a diagram showing an example of a processing flow of the computation apparatus according to the first embodiment.

FIG. 4 is a diagram showing an example configuration of a computer to which the present method is applied.

### DESCRIPTION OF EMBODIMENTS

Hereinafter, the embodiment of the present invention will be described. Note that in the diagrams used in the following description, constituent units with the same functions and steps in which the same processing is performed are assigned the same signs, and redundant description is omitted. In the following description, processing performed for each element unit of a vector or a matrix is assumed to be applied to all elements of that vector or matrix, unless otherwise noted.

### First Embodiment

First, the points of the present embodiment will be described, and then the notation used in the present embodiment will be described.

### Points of the Present Embodiment

In the present embodiment, the maximum value of an intermediate computation result is reduced from n² to n by devising the computation method, thereby avoiding overflow. In addition, division by zero in the secure odds ratio computation is detected by effectively combining comparison, logic, and selection operations, and ⊥ is returned if division by zero occurs. Here, ⊥ indicates an invalid value.

<Encryption>

A value obtained by encrypting a in some way is called a ciphertext of a, and is denoted as [[a]]. Also, a is called a plaintext value of the ciphertext [[a]].

The following arithmetic operations, logical operations, equality judgments, and selections are performed by means of secure computation. Note that the method for encryption in secure computation may be any method. For example, any of the methods described in NPL 1 and 2, or the like, is used.

<Arithmetic Operations>

Each operation of addition, subtraction, multiplication, and division by means of secure computation takes ciphertexts [[a]] and [[b]] of a and b as input, and outputs ciphertexts [[c₁]], [[c₂]], [[c₃]], and [[c₄]] of the results c₁, c₂, c₃, and c₄ of calculating a+b, a−b, ab, and a/b, respectively. The execution of these operations is described as follows.

[[c₁]]←Add([[a]],[[b]])

[[c₂]]←Sub([[a]],[[b]])

[[c₃]]←Mul([[a]],[[b]])

[[c₄]]←Div([[a]],[[b]])

Note that, in the following, Add([[a]], [[b]]), Sub([[a]], [[b]]), Mul([[a]], [[b]]), and Div([[a]], [[b]]) are also denoted as [[a]]+[[b]], [[a]]-[[b]], [[a]]×[[b]], [[a]]/[[b]], respectively.

<Logical Operations>

The Or operation by means of secure computation takes the ciphertexts [[a]] and [[b]] of 1-bit values a and b as input, and outputs a ciphertext [[c]] of a result c of calculating a Or b. The execution of this operation is described as follows. [[c]]←Or([[a]], [[b]])

<Equality Judgment>

The operation of equality judgment takes the ciphertexts [[a]] and [[b]] of a and b as input, and outputs the ciphertext [[c]] of a truth value c of a predicate a=?b. The execution of this operation is described as follows. [[c]]←[[a]]=?[[b]]

<Selection>

The selection takes the ciphertexts [[c]], [[a]], and [[b]] of a truth value c∈{0,1} and a and b, and outputs a ciphertext [[d]] of d that satisfies

$$d = \{ \begin{matrix}a if c = 1 \\ b otherwise\end{matrix} \qquad [ Math . 2 ]$$

The execution of this operation is described as follows.

[[d]]←If Else([[c]],[[a]],[[b]])

<Secure Summary Table Computation>

An encrypted summary table itself used as input for the secure odds ratio computation can also be calculated by means of secure computation. In the following, processing for reading an encrypted database [[D]] and returning the ciphertexts ([[a]], [[b]], [[c]], [[d]]) of a contingency table is denoted as ([[a]], [[b]], [[c]], [[d]])←Count([[D]]). There are several possible ways to realize Count ([[D]]), but for example, if n is known and it is assumed the format of the database takes two values of [[0]], [[1]] and has two attributes, subtotal portions (n₁., n₂., n.₁, n.₂) and a can be calculated by addition and constant multiplication. Then, all elements of the summary table can be calculated based on the relationship between the subtotals and each element.

### First Embodiment

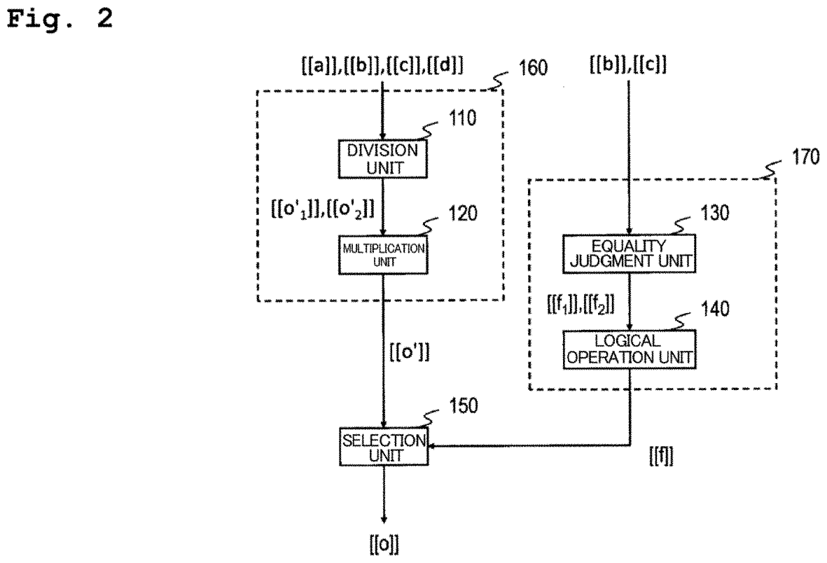

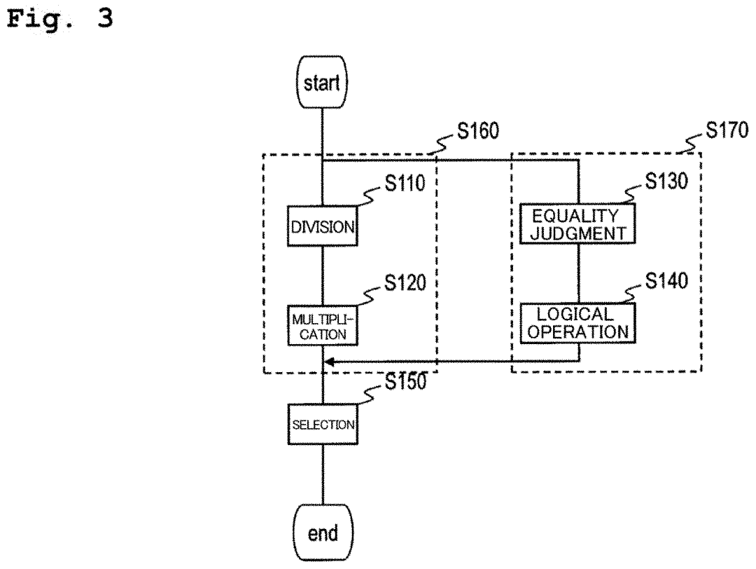

FIG. 2 is a functional block diagram of a computation apparatus according to the first embodiment, and FIG. 3 is a processing flow thereof.

The computation apparatus includes a division unit 110, a multiplication unit 120, an equality judgment unit 130, a logical operation unit 140, and a selection unit 150.

The computation apparatus receives input of the ciphertexts [[a]], [[b]], [[c]], and [[d]], obtains an odds ratio o by means of secure computation, and outputs the obtained odds ratio o or ⊥ indicating an invalid value. Note that the computation apparatus may calculate the ciphertexts [[a]], [[b]], [[c]], and [[d]] by calculating a pre-calculated summary table, or by performing secure summary table computation with the encrypted database [[D]] as input.

The computation apparatus is, for example, a special device configured by loading a special program into a known or dedicated computer that has a central processing unit (CPU), a main storage device (RAM: Random Access Memory), and so on. The computation apparatus executes each processing under the control of the central processing unit, for example. Data input to the computation apparatus and data obtained by each processing is, for example, stored in the main storage device, and the data stored in the main storage device is loaded to the central processing unit and used in other processing as necessary. Each processing unit of the computation apparatus may be constituted at least partially by hardware such as an integrated circuit. Each storage unit included in the computation apparatus may be constituted by, for example, a main storage device such as a RAM (Random Access Memory) or middleware such as a relational database or a key-value store. However, each storage unit does not necessarily need to be installed in the computer, but may alternatively be constituted by an auxiliary storage device constituted by an auxiliary storage device consisting of a hard disk, an optical disk, or a semiconductor memory device such as a flash memory (Flash Memory), and installed outside the computation apparatus.

Each unit will be described below.

<Division Unit 110>

The division unit 110 takes the ciphertexts [[a]], [[b]], [[c]], and [[d]] as input, obtains ciphertexts [[o′₁]] and [[o′₂]] of results o′₁ and o′₂ of calculating a/b and d/c using the following expressions (2) and (3) (S110), and outputs ciphertexts [[o′₁]], [[o′₂]].

[[o′₁]]←[[a]]/[[b]] (2)

[[o′₂]]←[[d]]/[[c]] (3)

<Multiplication Unit 120>

The multiplication unit 120 takes the ciphertext [[o′₁]], [[o′₂]] as input, obtains, using the following expression (4), a ciphertext [[o′]] of a result o′ of the computation of plaintext values o′₁×o′₂ (S120), and outputs the ciphertext [[o′]].

[[o′]]←[[o′₁]]×[[o′₂]] (4)

In other words, the odds ratio o′ that is calculated based on a, b, c, and d in the 2×2 summary table is obtained by the expressions (2)-(4). In other words, the odds ratio between the first group (a+b) and the second group (c+d) are obtained based on the four plaintext values a, b, c, and d. Accordingly, the division unit 110 and the multiplication unit 120 are also collectively called an odds ratio computation unit 160, and processing performed thereby is S160.

<Equality Judgment Unit 130>

The equality judgment unit 130 takes the ciphertext [[b]] and [[c]] as input, obtains ciphertexts [[f₁]] and [[f₂]] of truth values f₁ and f₂ with predicates b=?0 and c=?0 by the following expression (S130), and outputs the ciphertexts [[f₁]] and [[f₂]].

[[f₁]]←[[b]]=?[[0]] (5)

[[f₂]]←[[c]]=?[[0]] (6)

<Logical Operation Unit 140>

The logical operation unit 140 takes the ciphertexts [[f₁]] and [[f₂]] as input, obtains a ciphertext [[f]] of a result f of calculating f₁ Or f₂ by the following expression (S140), and outputs the ciphertext [[f]].

[[f]]←Or([[f₁]],[[f₂]]) (7)

<Selection Unit 150>

The selection unit 150 takes the ciphertexts [[f]] and [[o′]] as input, obtains a ciphertext [[o]] of o that satisfies

$$o = \{ \begin{matrix}⊥ if f = 1 \\ {o}^{′} otherwise\end{matrix} \qquad [ Math . 3 ]$$

by the following equation (S150), and outputs the ciphertext [[o]].

[[o]]←If Else([[f]],[[⊥]],[[o′]]) (8)

That is to say, division by zero is detected by the expressions (5) to (7). Accordingly, the equality judgment unit 130 and the logical operation unit 140 are also collectively called a zero-division detection unit 170, and processing performed thereby is S170. By the expression (8), the selection unit 150 selects a ciphertext [[⊥]] of ⊥ indicating an invalid value if division by zero is detected, or selects a ratio ciphertext [[o′]] of the odds ratio o′ if division by zero is not detected, and outputs the selection result [[o]].

### Effects

In the present embodiment, division by zero is detected by effectively combining comparison, logic, and selection operations as represented by the expressions (5) to (8), and replaces the computation result of (4) with ⊥ if division by zero is detected.

When the expression (1) is simply calculated, division and comparison operations can be done at a time by calculating ad and bc and thereafter performing division. In this method, however, overflow occurs when values to be handled are large, and a correct computation result cannot be obtained. In the present embodiment, the number of times of costly division increases compared with multiplication, but instead, the largest value during computation decreases from n² to n as a result of calculating [[o′₁]]←[[a]]/[[b]] and [[o′₂]]←[[d]]/[[c]] and thereafter calculating the product [[o′]]←[[o′₁]]×[[o′₂]], and thus, large values can be handled while avoiding overflow.

In other words, when secure computation of the odds ratio using the expression (1) is performed by means of fixed-point arithmetic, it is possible to detect division by zero and distinguish it from the correct computation result even in secure computation in which the intermediate computation result is invisible. In addition, large input can also be dealt with by avoiding overflow.

<Other Modifications>

The present invention is not limited to the above embodiments and modifications. For example, various types of processing described above may be not only performed in time-series in accordance the description, but also performed in parallel or separately in accordance with the performance of the device that performs processing, or as required. In addition, the present invention may be modified, as appropriate, within the scope of the gist thereof.

<Program and Recording Medium>

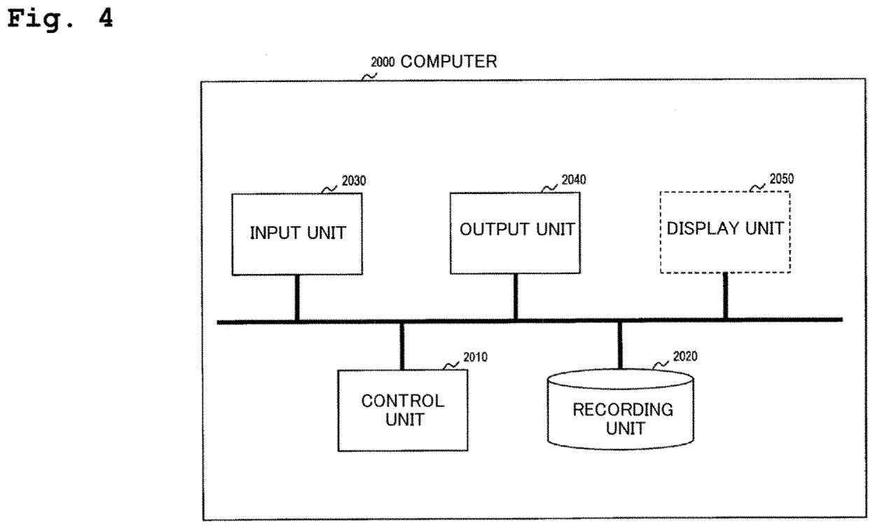

The above-described processing can be implemented by causing a recording unit 2020 of a computer shown in FIG. 4 to load a program for executing the steps of the above-described method, and causing a control unit 2010, an input unit 2030, an output unit 2040, and so on, to operate.

The program that describes this processing content can be recorded in a computer-readable recording medium. The computer-readable recording medium may be of any kind, e.g., a magnetic recording device, an optical disk, a magneto-optical recording medium, a semiconductor memory, or the like.

This program is distributed by, for example, selling, transferring, or lending a portable recording medium, such as a DVD or a CD-ROM, in which the program is recorded. Furthermore, a configuration is also possible in which this program is stored in a storage device in a server computer, and is distributed by transferring the program from the server computer to other computers via a network.

For example, first, a computer that executes such a program temporarily stores the program recorded in the portable recording medium or the program transferred from the server computer in a storage device of this computer. When executing the processing, the computer loads the program stored in its own storage medium, and executes processing in accordance with the loaded program. As another mode of executing this program, the computer may directly load the program from the portable recording medium and execute processing in accordance with the program, or may sequentially execute processing in accordance with a received program every time the program is transferred from the server computer to this computer. A configuration is also possible in which the above-described processing is executed through a so-called ASP (Application Service Provider)-type service that realizes processing functions only by giving instructions to execute the program and acquiring the results, without transferring the program to the computer. Note that the program in this mode may include information for use in processing performed by an electronic computer that is equivalent to a program (e.g., data that is not a direct command to the computer but has properties that define computer processing).

In this mode, the present device is configured by executing a predetermined program on a computer, but the content of this processing may be at least partially realized in a hardware manner.

1-5. (canceled)

6. A computation apparatus comprising:
processing circuitry configured to:
execute an odds ratio computation processing in which the processing circuitry obtains an odds ratio between a first group (a+b) and a second group (c+d) based on four plaintext values a, b, c, and d, by means of secure computation;
execute a zero-division detection processing in which the processing circuitry determines, by means of secure computation, whether or not at least one of the plaintext values b and c is not zero, and detects division by zero; and
a selection processing in which the processing circuitry selects the odds ratio if division by zero is not detected, by means of secure computation,
wherein in the odds ratio computation processing the processing circuitry obtains ciphertexts [[0′₁]] and [[0′₂]] of results o′₁ and o′₂ of calculating a/b and d/c, respectively, by means of secure computation, and thereafter obtains a ciphertext of a result o′ of calculating o′₁×o′₂.

7. A computation apparatus comprising:
processing circuitry configured to:
take ciphertexts [[a]], [[b]], [[c]], and [[d]] of plaintext values a, b, c, and d as input, and obtain ciphertexts [[o′₁]] and [[o′₂]] of results o′₁ and o′₂ of calculating a/b and d/c, respectively, by [[o′₁]]←[[a]]/[[b]] and [[o′₂]]←[[d]]/[[c]], by means of secure computation;
take the ciphertexts [[o′₁]] and [[o′₂]] as input and obtain a ciphertext [[o′]] of a result o′ of computation of plaintext values o′₁×o′₂ by [[o′]]←[[o′₁]]×[[o′₂]], by means of secure computation;
take the ciphertexts [[b]] and [[c]] as input and obtain ciphertexts [[f₁]] and [[f₂]] of truth values f₁ and f₂ with predicates b=?0 and c=?0, respectively, by [[f₁]]←[[b]]=?[[0]] and [[f₂]]←[[c]]=?[[0]], by means of secure computation;
take the ciphertexts and as input and obtain a ciphertext [[f]] of a result f of calculating f₁ Or f₂ by [[f]]←Or([[f₁]], [[f₂]]), by means of secure computation; and
take the ciphertexts [[f]] and [[o′]] as input and obtain a ciphertext [[o]] of o that satisfies
$$o = \{ \begin{matrix}⊥ if f = 1 \\ {o}^{′} otherwise\end{matrix} \qquad [ Math . 4 ]$$
by [[o]]←If Else([[f]], [[⊥]], [[o′]]), by means of secure computation, wherein ⊥ indicates an invalid value.

8. A computation method, implemented by a computation apparatus that includes processing circuitry, comprising:
an odds ratio computation step in which the processing circuitry obtains an odds ratio between a first group (a+b) and a second group (c+d) based on four plaintext values a, b, c, and d, by means of secure computation;
a zero-division detection step in which the processing circuitry determines, by means of secure computation, whether or not at least one of the plaintext values b and c is not zero, and detects division by zero; and
a selection step in which the processing circuitry selects the odds ratio if division by zero is not detected, by means of secure computation,
wherein in the odds ratio computation step, the processing circuitry obtains ciphertexts [[o′₁]] and [[o′₂]] of results o′₁ and o′₂ of calculating a/b and d/c, respectively, by means of secure computation, and thereafter, obtains a ciphertext [[o′]] of a result o′ of calculating o′₁×o′₂.

9. A computation method, implemented by a computation apparatus that includes processing circuitry, comprising:
a division step in which the processing circuitry takes ciphertexts [[a]], [[b]], [[c]], and [[d]] of plaintext values a, b, c, and d as input, and obtains ciphertexts [[o′₁]] and [[o′₂]] of results o′₁ and o′₂ of calculating a/b and d/c, respectively, by [[o′₁]]←[[a]]/[[b]] and [[o′₂]]←[[d]]/[[c]], by means of secure computation;
a multiplication step in which the processing circuitry takes the ciphertexts [[o′₁]] and [[o′₂]] as input and obtains a ciphertext [[o′]] of a result o′ of computation of plaintext values o′₁×o′₂ by [[o′]]←[[o′₁]]×[[o′₂]], by means of secure computation;
an equality judgment step in which the processing circuitry takes the ciphertexts [[b]] and [[c]] as input and obtains ciphertexts [[f₁]] and [[f₂]] of truth values f₁ and f₂ with predicates b=?0 and c=?0, respectively, by [[f₁]]←[[b]]=?[[0]] and [[f₂]]←[[c]]=?[[0]], by means of secure computation;
a logical operation step in which the processing circuitry takes the ciphertexts [[f₁]] and [[f₂]] as input and obtains a ciphertext [[f]] of a result f of calculating f₁ Or f₂ by [[f]]←Or([[f₁]], [[f₂]]), by means of secure computation; and
a selection step in which the processing circuitry takes the ciphertexts [[f]] and [[o′]] as input and obtains a ciphertext [[o]] of o that satisfies
$$o = \{ \begin{matrix}⊥ if f = 1 \\ {o}^{′} otherwise\end{matrix} \qquad [ Math . 5 ]$$
by [[o]]←If Else([[f]], [[⊥]], [[o′]]), by means of secure computation, wherein ⊥ indicates an invalid value.

10. A non-transitory computer-readable recording medium having recorded thereon a program for causing a computer to function as the computation apparatus according to claim 6.

11. A non-transitory computer-readable recording medium having recorded thereon a program for causing a computer to function as the computation apparatus according to claim 7.
